(19) United States
(12) Patent Application Publication
(10) Pub. No.: US 2008/0089470 A1
(43) Pub. Date: Apr. 17, 2008

(54) Alignment for contact lithography

(76) Inventors: Robert G. Walmsley, Palo Alto, CA (US); Inkyu Park, Albany, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/580,676

(22) Filed: Oct. 13, 2006

(51) Int. Cl. G21K 5/00

(52) U.S. Cl. 378/34

(57) ABSTRACT

A contact lithography system includes a patterning tool for transferring a pattern to a substrate; and a capacitive alignment system disposed on the patterning tool for cooperating with a corresponding alignment system disposed on the substrate for determining relative alignment of the patterning tool and substrate. A method of aligning a patterning tool and a substrate in a contact lithography system includes determining, based on a signal transferred through capacitors formed by opposing conductive elements disposed respectively on the patterning tool and substrate, alignment of the patterning tool and substrate.

### BACKGROUND

Contact lithography involves direct contact between a patterning tool (e.g., a mask, mold, template, etc.) and a substrate on which micro-scale and/or nano-scale structures are to be fabricated. Photographic contact lithography and imprint lithography are two examples of contact lithography methodologies.

In photographic contact lithography, the patterning tool (e.g., a mask) is aligned with and then brought into contact with the substrate or a pattern-receiving layer of the substrate. Some form of light or radiation is then used to expose those portions of the substrate that are not covered by the mask so as to transfer the pattern of the mask to the pattern-receiving layer of the substrate. Similarly, in imprint lithography, the patterning tool (e.g., a mold) is aligned with the substrate after which the mold is pressed into the substrate such that the pattern of the mold is imprinted on, or impressed into, a receiving surface of the substrate.

With either method, alignment between the patterning tool and the substrate is very important. The method for aligning the patterning tool and substrate generally involves holding the patterning tool a small distance above the substrate while relative lateral and rotational adjustments (e.g., x-y translation and/or angular rotation adjustments) are made. Either the patterning tool or the substrate, or both, may be moved during the process of alignment. The patterning tool is then brought into contact with the substrate to perform the lithographic patterning.

As will be appreciated, the alignment between the patterning tool and the substrate must be very precise given the micro-scale or nano-scale structures being formed by these lithographic techniques. Any of a wide number of factors can cause misalignment that may, even if only minor, be detrimental to the operation of the device being fabricated. For example, there may be some vibration of the patterning tool and/or substrate during the alignment process. Vibration also affects systems, usually optical systems, that are used to measure or verify the alignment between the patterning tool and the substrate.

The vibrations experienced by such alignment measuring systems are generally not consistent with the vibrations experienced by the patterning tool and substrate being measured. Consequently, it becomes difficult to accurately measure and adjust alignment. For example, a microscope for detecting the alignment of a patterning tool and substrate experiences vibrations different from those experienced by the patterning tool and substrate. The differential vibrations blur the image captured by the microscope and consequently decrease the sensitivity of alignment measurements making it difficult to ensure accurate alignment between the patterning tool and substrate.

### BRIEF DESCRIPTION OF THE DRAWINGS

The accompanying drawings illustrate various embodiments of the principles being described in this specification and are a part of the specification. The illustrated embodiments are merely examples and do not limit the scope of the principles described herein.

FIG. 1 is a schematic side view of a contact lithography apparatus with a capacitive alignment system for determining the alignment between a patterning tool and a substrate, according to one exemplary embodiment.

FIG. 2 is a diagram of an alignment system including an alignment detection circuit, alignment processor and alignment servo system that may be used with a capacitive alignment system such as that illustrated FIG. 1, according to one exemplary embodiment.

FIG. 3 is a diagram of a substrate incorporating a capacitive alignment system, according to one exemplary embodiment.

FIG. 4 is a flowchart illustrating a process of aligning a patterning tool and substrate in a contact lithography system using a capacitive alignment system, according to one exemplary embodiment.

Throughout the drawings, identical reference numbers designate similar, but not necessarily identical, elements.

### DETAILED DESCRIPTION

The present specification describes exemplary methods and systems that facilitate alignment of a patterning tool and a substrate for contact lithography. To improve the accuracy, precision, and vibration tolerance of the alignment between the patterning tool and substrate, a capacitive alignment system is incorporated into the patterning tool and substrate. This capacitive alignment system uses a signal transmitted through capacitively paired conductors that are disposed respectively on the patterning tool and substrate to determine the proper alignment of the patterning tool with respect to the substrate or vice versa. Because the capacitive alignment system is integrated into the patterning tool and substrate being aligned, the issues associated with having an alignment system experience different vibrations than the members being aligned are ameliorated.

As used herein and in the appended claims, the term “contact lithography” generally refers to any lithographic methodology that employs a direct or physical contact between a patterning tool or means for providing a pattern and a substrate or means for receiving the pattern, including a substrate having a pattern receiving layer thereon. Specifically, “contact lithography” as used herein includes, but is not limited to, any form of imprint lithography or photographic contact lithography.

As mentioned above, and by way of example, in imprint lithography, the patterning tool is a mold that transfers a pattern to the substrate through an imprinting process. In some embodiments, physical contact between the mold and a layer of formable or imprintable material on the substrate transfers the pattern to the substrate. Imprint lithography, as well as a variety of applicable imprinting materials, are described in U.S. Pat. No. 6,294,450 to Chen et al. and U.S. Pat. No. 6,482,742 B1 to Chou, both of which are incorporated herein by reference in their respective entireties.

In photographic contact lithography, a physical contact is established between a patterning tool, in this case called a photomask or, more simply, a mask, and a photosensitive resist layer on the substrate that serves as the pattern receiving layer. During the physical contact, visible light, ultraviolet (UV) light, or another form of radiation passing through selected portions of the photomask exposes the photosensitive resist or photoresist layer on the substrate. The photoresist layer is then developed to remove portions that don't correspond to the pattern. As a result, the pattern of the photomask is transferred to the substrate.

For simplicity in the following discussion, no distinction is generally made between the substrate and any layer or structure on the substrate (e.g., a photoresist layer or imprintable material layer) unless such a distinction is helpful to the explanation. Consequently, reference herein is generally to the “substrate” irrespective of whether a resist layer or an imprintable material layer is or is not employed on the substrate to receive the pattern. One of ordinary skill in the art will appreciate that a resist or imprintable material layer may always be employed on the substrate of any contact lithography methodology according to the principles being described herein.

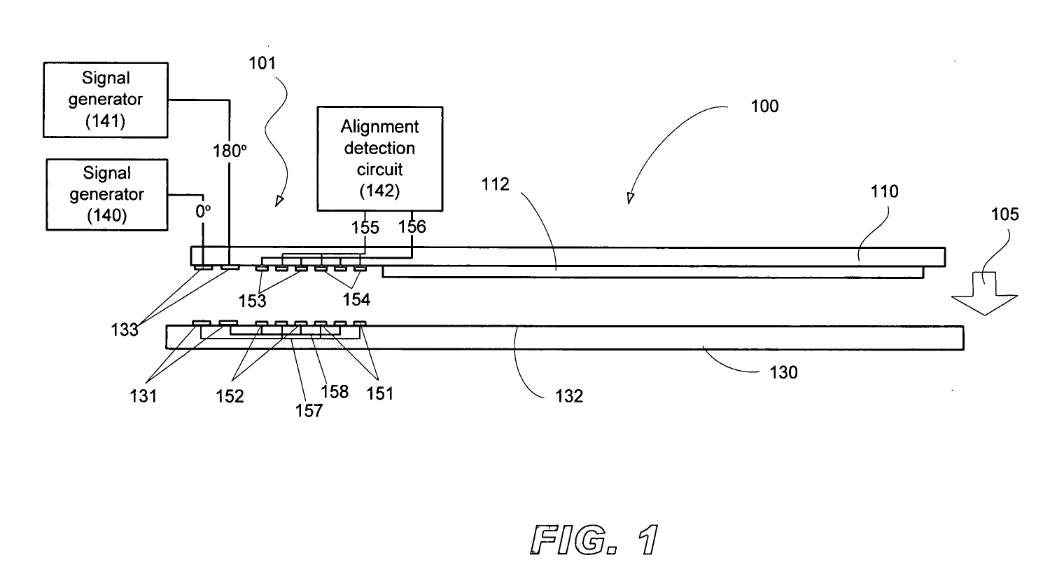

FIG. 1 is a schematic side view of a contact lithography apparatus with a capacitive alignment system (101) for determining the alignment between a patterning tool and a substrate, according to one exemplary embodiment. In the example of FIG. 1, the contact lithography apparatus (100) shown is an imprint lithography system and the patterning tool (110) is, consequently, a mold. It will be appreciated, however, that the same alignment system (101) may be implemented in a photolithography system in which the patterning tool is a mask.

As shown in FIG. 1, a substrate (130) is prepared to receive an imprinted pattern from the patterning tool (110). The substrate (130) may be, in some examples, a semiconductor wafer. The patterning tool (110) includes a physical relief pattern (112) that is imprinted or stamped onto or into a surface (132) of the substrate (130) so as to form a structure corresponding to the pattern (112) on the substrate (130).

The surface (132) of the substrate that receives the pattern may be a natural surface of the substrate (130) or may be a layer of material specifically deposited on the substrate (130) to receive the pattern of the patterning tool (110). The arrow (105) represents the action of applying pressure between the mold (112) and the substrate (130) to from a desired structure on the substrate (130) corresponding to the main pattern (112) of the patterning tool (110).

On the left side of the patterning tool (110) and substrate (130), as illustrated in the example of FIG. 1, is the capacitive alignment system (101). The capacitive alignment system (101) includes two arrays of conductors (151, 152) disposed on the substrate (130) and two corresponding arrays of conductors (153, 154) disposes on the patterning tool (110).

As will be appreciated by those of ordinary skill in the art, each of the conductors in the two arrays (151-154) can be paired with a respective conductor on the other of the patterning tool (110) or substrate (130) to form a capacitor. The spacing between the patterning tool (110) and substrate (130), which is typically filled with air at normal atmospheric pressure, provides the dielectric element between each of the two respective conductors that form a capacitor.

As shown in FIG. 1, the elements of the two conductor arrays (151, 152) on the substrate (130) may be interspersed with each other. That is, the two arrays (151, 152) are arranged as a single linear array, with elements of the two individual arrays (151, 152) alternating along the length of the line of conductors that includes both arrays (151, 152). However, other configurations for the two arrays (151, 152) may be used. For example, the arrays (151, 152) may be separated, each comprising a linear array with both linear arrays arranged along a single line end-to-end. Any number of other configurations may also be used.

Two corresponding arrays (153, 154) are disposed on the patterning tool (110). The configuration of the arrays (153, 154) on the patterning tool (110) will match that of the arrays (151, 152) on the substrate (130). Consequently, when the patterning tool (110) and substrate (130) are brought into close proximity and aligned, the two arrays (153, 154) on the patterning tool (110) will match up spatially with the two arrays (151, 152) on the substrate (130) such that each element of each array (153, 154) on the patterning tool (110) is aligned with a corresponding element of an array (151, 152) on the substrate (130) to form a capacitor.

Turning again to the arrays (151, 152) on the substrate (130), each element of the first array (151) is electrically connected (157) to one of a pair of terminals (131). Each element of the second array (152) is electrically connected (158) to the other of the pair of terminals (131). A corresponding pair of terminals (133) is disposed on the patterning tool (110).

The two pairs of terminals (131, 133) include conductors located on the surfaces of the patterning tool (110) and substrate (130) respectively such that when the patterning tool (110) and substrate (130) are brought into close proximity, the terminals (131, 133) form a pair of capacitors in the same manners as the matched elements of the arrays (151-154) described above.

A first signal generator (140) is connected to one of the terminals (133) on the patterning tool (110). This signal generator (140) produces a periodic electrical signal. This periodic signal may-be, for example, a sine wave or other periodic waveform.

When the patterning tool (110) is in close proximity with the substrate (130), such that the terminals (131, 133) form a pair of capacitors, the periodic signal from the first signal generator (140) will be transmitted through the capacitor formed by a corresponding pair of the terminals (131, 133) and thence to the corresponding array (151) on the substrate (130).

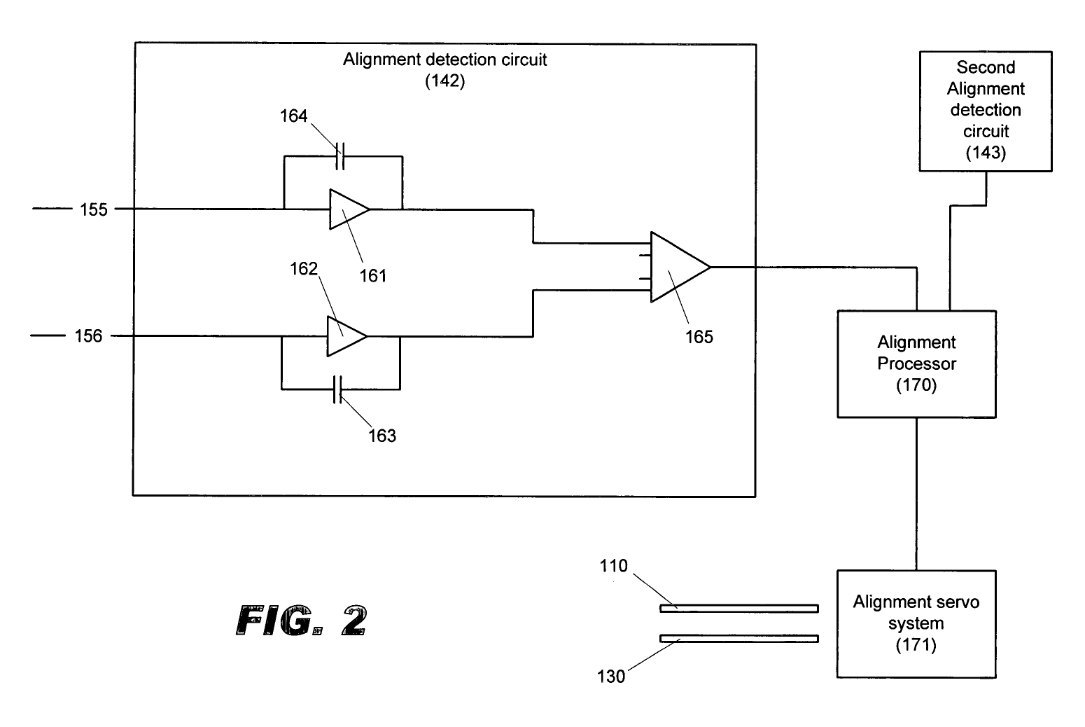

As described above, that corresponding array (151) will also be in a capacitive relationship with an array (154) on the patterning tool (110). Thus, the periodic signal from the signal generator (140) will be transmitted through the capacitors formed by the arrays (151, 154) back to the patterning tool (110). The signal is then input through a connection (155) from that array (154) on the patterning tool (110) to an alignment detection circuit (142) that will be described in more detail below with respect to FIG. 2.

A second signal generator (141) is connected to the other of the two terminals (133) on the patterning tool (110). This signal generator (141) produces a periodic electrical signal that is identical to that produced by the first signal generator (140) with the exception that the signal produced by the second signal generator (141) is 180° out of phase with the signal produced by the first signal generator (140).

As described above, when the patterning tool (110) is in close proximity with the substrate (130) such that the terminals (131, 133) form a pair of capacitors, the periodic signal from the second signal generator (141) will be transmitted through the other capacitor formed by a pair of the terminals (131, 133) and to the corresponding array (152) on the substrate (130).

That corresponding array (152) will also be in a capacitive relationship with a corresponding array (153) on the patterning tool (110). Thus, the periodic signal from the second signal generator (141) will be transmitted through the capacitors of the arrays (152, 153) back to the patterning tool (110). The signal is then input through a connection (156) from that array (153) on the patterning tool (110) to the alignment detection circuit (142).

As will be appreciated by those skilled in the art, the configuration described herein is only one example of the principles being disclosed. For instance, the signal generators (140, 141) may, alternatively, be connected to the terminals (131) on the substrate (130) and the alignment detection circuit (142) may, alternatively, be connected to the two arrays (151, 152) on the substrate (130) rather than the arrays (153, 154) on the patterning tool (110). In such an embodiment, the terminals (133) and the arrays (153, 154) on the patterning tool (110) would be interconnected using connections similar to those (157,158) presently shown in connection with the substrate (130).

FIG. 2 is a diagram of an alignment system including an alignment detection circuit, alignment processor and alignment servo system that may be used, for example, with the capacitive alignment system of FIG. 1. As shown in FIG. 2, the alignment detection circuit (142) receives the output (155, 156) from the two arrays (153, 154, FIG. 1) on the patterning tool (110) and then outputs a signal to an alignment processor (170) that is indicative of the relative alignment of the patterning tool (110) and the substrate (130).

Within the alignment detection circuit (142), the signal (155, 156) from each array is input respectively, in parallel, to an amplifier (161, 162) and a capacitor (163, 164). Then, each signal (155, 156), after being transmitted in parallel through a respective amplifier/capacitor circuit, is input to a summing amplifier (165).

Because the signals from the two signal generators (140, 141) are 180° out of phase, if all the elements of the arrays (151-154) are properly aligned to form the desired capacitors described above, each of the signals (155, 156) will be equal in amplitude and 180° out of phase. Consequently, the summing amp (165) will add the two signals (155, 156) and produce a null output. If the arrays (151-154) are not properly aligned, some of the capacitive pairs will produce a stronger or weaker relative signal depending on the degree to which each such pair is or is not aligned, and the summing amp (165) will consequently output a non-null signal.

Therefore, when the summing amp (165) outputs a null signal, that indicates that the patterning tool (110) and the substrate (130) are aligned with respect, at least, to the line or axis along with the arrays (151-154, FIG. 1) are disposed. As shown in FIG. 2, the alignment processor (170) receives the output of the summing amp (165) and is configured to determine whether the output is or is not null, indicating whether the patterning tool (110) and the substrate (130) are aligned with respect, at least, to the line or axis along with the arrays (151-154, FIG. 1) are disposed.

The alignment processor (170) is also connected to an alignment servo system (171). The alignment servo system (171) is configured to manipulate and adjust the relative alignment of the patterning tool (110) and the substrate (130). In this regard, the alignment servo system (171) may be configured to move the pattering tool (110) relative to the substrate (130), move the substrate (130) relative to the patterning tool (110) or move both the substrate (130) and the patterning tool (110) to adjust their relative positioning and alignment.

If the alignment processor (170) receives a non-null signal from the alignment detection circuit (142), the alignment processor (170) is programmed to drive the alignment servo system (171) to change the relative positioning and alignment of the patterning tool (110) and the substrate (130). As will be described in more detail below, the alignment processor (170) may continued to drive the alignment servo system (171) and reposition the patterning tool (110) and/or the substrate (130) until a null signal is received from the alignment detection circuit (142), indicating a desired alignment between the patterning tool (110) and substrate (130). The alignment processor (170) may also be programmed to determine, based on a change in the signal from the alignment detection circuit (142), in which direction or directions the alignment servo system (171) must move the patterning tool (110) or substrate (130) to produce the desired alignment.

As indicated above, when the alignment detection circuit (142) outputs a null signal, the substrate (130) and patterning tool (110) are aligned with respect to an axis along which the arrays (151-154, FIG. 1) of the capacitive alignment system (101) are disposed. However, alignment along a single axis may, in most cases, be insufficient to ensure that the patterning tool (110) and substrate (130) are properly aligned for contact lithography. Consequently, to fully align the substrate (130) and the patterning tool (110), the capacitive alignment system (101) shown in FIG. 1, for example, may be doubled or duplicated with the arrays of the second such system being aligned orthogonally to the arrays of the first system (101) such that alignment of the patterning tool (110) and substrate (130) with respect to two orthogonal axes can be determined.

A second alignment detection circuit (143) is also provided to receive the outputs of this second capacitive alignment system. The alignment processor (170) is accordingly programmed to fully align the patterning tool (110) and substrate (130) using the output of both the first alignment detection circuit (142) and the second alignment detection circuit (143). The alignment processor (170) drives the alignment servo system (171) until both the first and second alignment detection circuits (142, 143) both produce a null signal.

When a null signal is received from both the first and second alignment detection circuits (142, 143), this indicates to the alignment processor (170) that the patterning tool (110) and the substrate (130) are fully aligned with respect to two mutually orthogonal axes and are, therefore, aligned such that the contact lithography process can commence to transfer the pattern (112, FIG.1) from the patterning tool (110) to the substrate (130).

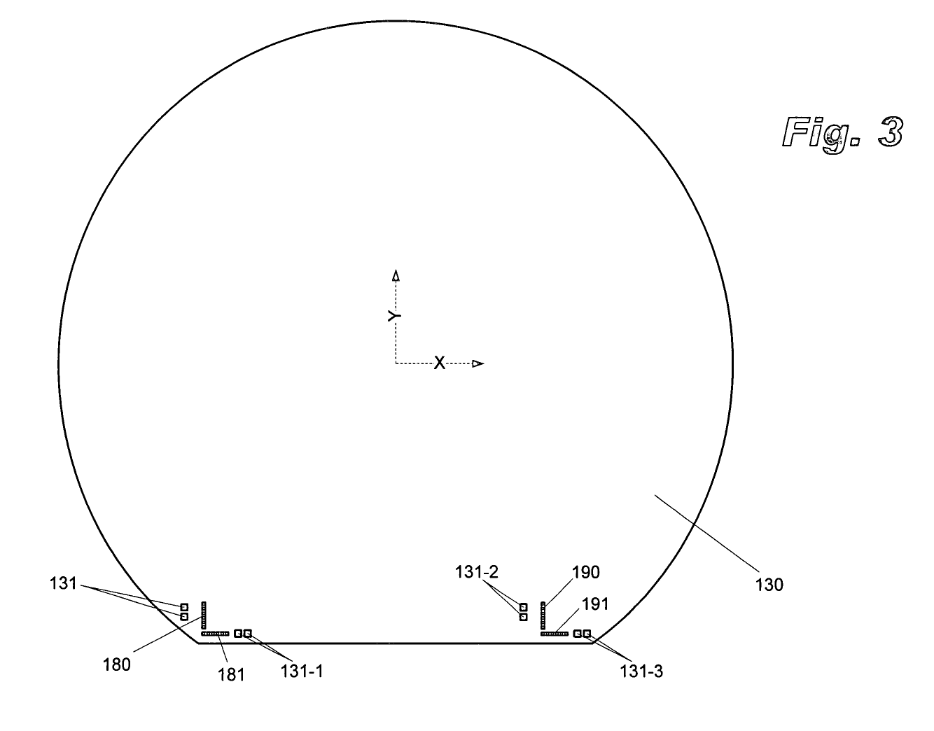

FIG. 3 is a diagram of a substrate incorporating a capacitive alignment system, according to one exemplary embodiment. In the example illustrated in FIG. 3, the substrate (130) is a semiconductor wafer on which has been formed corresponding portions of the capacitive alignment system (101) described above.

In the example of FIG. 3, two pairs of arrays of conductive elements, four arrays total, are arranged on the substrate (130). As shown in FIG. 3, one pair of arrays (180) is arranged as a single linear array that is aligned with a first or Y axis of the substrate (130). As indicated above, the pair of arrays may consist of alternating elements within the linear pair of arrays (180).

This pair of arrays (180) is also electrically connected to a pair of terminals (131) in the manner illustrated in FIG. 1. Specifically, each of the elements of one of the two arrays (180) is connected to one of the two terminals (131), and each of the elements of the other of the two arrays (180) is connected to the other of the two terminals (131).

Additionally, a second pair of arrays (181) is arranged as a single linear array that is aligned with a second or X axis of the substrate (130). As indicated above, this pair of arrays may be arranged as alternating elements within the linear pair of arrays (181).

This pair of arrays (180) is also electrically connected to a separate pair of terminals (130-1), again, in the manner illustrated in FIG. 1. Specifically, each of the elements of one of the two arrays (181) is connected to one of the two terminals (131-1), and each of the elements of the other of the two arrays (181) is connected to the other of the two terminals (131-1).

Consequently, the terminals (131) and the pair of arrays (180) correspond to the terminals (131) and pair of arrays (151, 152) shown on the substrate (130) illustrated in FIG. 1. Therefore, a patterning tool to be aligned with the substrate (130) shown in FIG. 3 would include the terminals (133) and arrays (153, 154) shown in FIG. 1, arranged so as to be aligned with the arrays (180) and terminals (131) of the substrate (130) when the patterning tool and substrate (130) are in alignment with respect to a Y axis.

Additionally, the terminals (131-1) and the pair of arrays (181) shown in FIG. 3 also correspond to the terminals (131) and pair of arrays (151, 152) shown on the substrate (130) illustrated in FIG. 1. Therefore, a patterning tool to be aligned with the substrate (130) shown in FIG. 3 would also include a second circuit include elements corresponding to the terminals (133) and arrays (153, 154) shown in FIG. 1. This additional set of terminals and arrays of conductive elements would be arranged, however, so as to be aligned with the arrays (181) and terminals (131-1) of the substrate (130) when the patterning tool and substrate (130) are in alignment with respect to an X axis.

Consequently, by aligning the first pair of arrays (180) with corresponding arrays on a patterning tool and aligning the second pair of arrays (181) with other corresponding arrays on a patterning tool, the substrate (130) is fully aligned with the patterning tool with respect to both the mutually-orthogonal X and Y axes. However, further rotational alignment may be needed.

It may be noted that the capacitive alignment system will also detect any rotation of either the substrate (130) or a corresponding patterning tool about either of the X or Y axes. If the system that physically moves the patterning tool and substrate allows for such relative rotation about either of the axes in the XY plane, that relative rotation will cause the distance between the conductive arrays on the patterning tool and substrate to vary along the length of at least one of the arrays. Consequently, the null signal being sought by the alignment processor (170, FIG. 2) will not be achieved until the rotation is corrected and both the patterning tool and substrate are mutually parallel with respect to the XY plane.

The capacitance arrays (180) and (181) provide for one point of alignment between the substrate and patterning tool in the XY plane. However, either or both of the substrate and patterning tool may be rotated within in the XY plane. Consequently, a second point of alignment can be used to ensure that the substrate and patterning tool are fully aligned, both as to the plane and rotation within the plane. Consequently, a second set of arrays (190, 191), identical to arrays (180, 181), can also be provided to determine a second point of alignment which accounts for rotational alignment within the XY plane. These arrays (190, 191) are operated, respectively, through terminals (131-2, 131-2) in the same manner described above with respect to the arrays (180, 181). The second set of arrays (190, 191) is located some distance from the first set of arrays (180, 181) as shown in FIG. 3. Generally, the further from the first set of arrays (180, 181) the second set or arrays (190, 191) is located, the more precise the alignment. Thus, in some embodiments, the second set of arrays (190, 191) may be located at a generally maximal distance from the first set of arrays (180, 181) as allowed by the size of the substrate and/or patterning tool. Each array is insensitive to motions orthogonal to its intended sensing direction over the range of motion allowed for final alignment. For example, array (181) should be maximally sensitive to displacements in the X direction, but insensitive to motions in the Y axis. Adjustment for X, Y and rotation alignment is achieved when signal outputs from all four arrays are nulled or minimized. At that point, the patterning tool and substrate are aligned such that a contact lithographic process can be conducted.

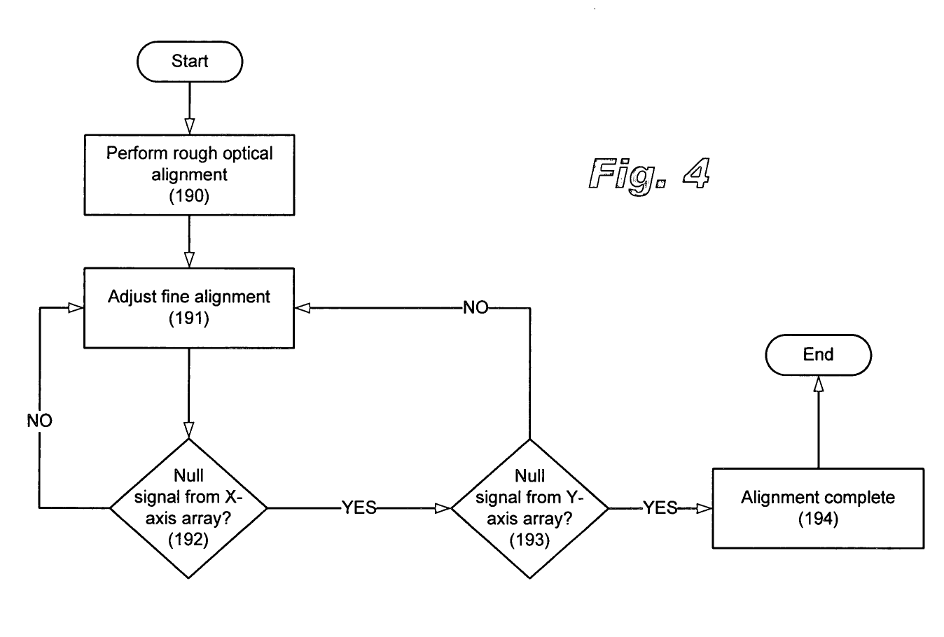

FIG. 4 is a flowchart illustrating a process of aligning a patterning tool and substrate in a contact lithography system using a capacitive alignment system, according to one exemplary embodiment. As shown in FIG. 4, the process starts by performing a rough optical alignment between the patterning tool and substrate (step 190).

As will be appreciated by those skilled in the art, the patterning tool and substrate are initially brought into proximity such that the arrays of conductive elements on the patterning tool and substrate can begin to function as capacitors, even if not precisely aligned. Additionally, the initial optical alignment brings the patterning tool and substrate into sufficient alignment such that the system operates within a single desired phase of the signals output by the signal generators (140, 141).

As will be appreciated by those of ordinary skill in the art, the systems being described herein can be implemented with an opaque patterning tool and substrate. However, an optically transparent patterning tool or substrate can also be used. Having an optically transparent patterning tool or substrate may facilitate the rough optical alignment being performed (step 190) in the method of FIG. 4.

Next, fine alignment adjustments can be made (step 191) using the capacitive alignment systems described above. For example, as described above with respect to FIG. 2, the alignment processor (170) can drive the alignment servo system (171) to make minute changes to the relative position and alignment of the patterning tool and substrate so as to align the patterning tool and substrate with respect to one, two or more degrees of freedom, for example, X and Y axes. The alignment servo system is capable of making very fine adjustments, on the order of nanometers, to the relative positions and orientation of the patterning tool and the substrate.

The alignment-servo system effects adjustment to the relative positions and orientation of the patterning tool and the substrate until the conductive arrays aligned along the X axis are producing a null signal (determination 192). Similarly, the alignment servo system effects adjustment to the relative positions and orientation of the patterning tool and the substrate until the conductive arrays aligned along the Y axis are also producing a null signal (determination 193).

As will be appreciated by those skilled in the art, the step of making fine adjustments (step 191) to the relative positions and orientation of the patterning tool and substrate can be performed with respect to the axes in any order. For example, the alignment may be performed first with respect to either the X or Y axis or may be performed with respect to both axes simultaneously.

When a null signal is achieved from both the X-axis arrays (determination 192) and the Y-axis arrays (determination 193), the patterning tool and substrate are satisfactorily aligned (step 194). The method of FIG. 4 is then complete and contact lithography between the aligned patterning tool and substrate can commence.

The preceding description has been presented only to illustrate and describe examples of the principles discovered by the applicants. This description is not intended to be exhaustive or to limit these principles to any precise form or example disclosed. Many modifications and variations are possible in light of the above teaching.

What is claimed is:

1. A contact lithography system comprising:
a patterning tool for transferring a pattern to a substrate; and
a capacitive alignment system disposed on said patterning tool for cooperating with a corresponding alignment system disposed on said substrate for determining relative alignment of said patterning tool and substrate.

2. The system of claim 1, wherein said capacitive alignment system comprises a plurality of arrays of conductive elements disposed on said patterning tool.

3. The system of claim 2, wherein said plurality of arrays comprises a first pair of arrays arranged along a first axis and a second pair of arrays arranged along a second axis that is orthogonal to said first axis.

4. The system of claim 3, wherein said plurality of arrays further comprises third and fourth pairs of arrays configured to detect rotational alignment.

5. A contact lithography system comprising:
a patterning tool;
a substrate; and
a capacitive alignment system disposed on said patterning tool and substrate for determining relative alignment of said patterning tool and substrate.

6. The system of claim 5, wherein said capacitive alignment system comprises a plurality of corresponding arrays of conductive elements disposed respectively on said patterning tool and said substrate, said conductive elements being paired to function as capacitors between said patterning tool and said substrate.

7. The system of claim 6, wherein said plurality of corresponding arrays comprises a first pair of arrays arranged along a first axis and a second pair of arrays arranged along a second axis that is orthogonal to said first axis, wherein said first and second pairs of arrays respectively comprise conductive elements from each of the array pairs alternately arranged as a linear array.

8. The system of claim 7, wherein said plurality of arrays further comprise third and fourth pairs of arrays configured to detect rotational alignment, wherein said second and third pairs of arrays respectively comprise conductive elements from each of the array pairs alternately arranged as a linear array.

9. The system of claim 6, further comprising first and second signal generators for inputting first and second periodic signals to respective terminals on said substrate or patterning tool.

10. The system of claim 9, wherein said first and second periodic signals are 180° out of phase.

11. The system of claim 9, wherein said terminals include terminals communicatively coupled to said first and second signal generators and corresponding terminals on the other of said substrate or patterning tool that form capacitors with said terminals respectively coupled to said first and second signal generators.

12. The system of claim 6, further comprising an alignment detection circuit communicatively coupled to the arrays disposed on either the substrate or the patterning tool, wherein said alignment detection circuit determines alignment between said patterning tool and said substrate based on signals routed through capacitors formed by proximity of the arrays respectively disposed on said substrate and patterning tool.

13. The system of claim 12, further comprising an alignment processor configured to determine alignment between said patterning tool and said substrate based on at least one null signal output by said alignment detection circuit.

14. The system of claim 13, further comprising an alignment servo system for adjusting relative positions and orientation of said patterning tool and substrate based on output from said alignment processor.

15. A method of aligning a patterning tool and a substrate in a contact lithography system comprising determining, based on a signal transferred through capacitors formed by opposing conductive elements disposed respectively on said patterning tool and substrate, alignment of said patterning tool and substrate.

16. The method of claim 15, further comprising aligning a plurality of corresponding arrays of conductive elements disposed respectively on said patterning tool and said substrate, said conductive elements being paired to function as capacitors between said patterning tool and said substrate.

17. The method of claim 16, wherein said plurality of corresponding arrays comprises a first pair of arrays arranged along a first axis and a second pair of arrays arranged along a second axis that is orthogonal to said first axis.

18. The method of claim 16, wherein said aligning a plurality of corresponding arrays comprises aligning four pairs of arrays of conductive elements to determine both planar and rotational alignment of said patterning tool and substrate.

19. The method of claim 16, further comprising inputting first and second periodic signals to respective terminals on said substrate or patterning tool, each terminal being electrically coupled with one of said arrays of conductive elements.

20. The method of claim 19, wherein said first and second periodic signals are 180° out of phase.

21. The method of claim 19, wherein said terminals include terminals communicatively coupled to said first and second signal generators and corresponding terminals on the other of said substrate or patterning tool that form capacitors with said terminals respectively coupled to said first and second signal generators.
